(19) United States
(12) Patent Application Publication
(10) Pub. No.: US 2020/0262215 A1
(43) Pub. Date: Aug. 20, 2020

(54) LABEL CREATION APPARATUS AND LABEL CREATION SYSTEM

(71) Applicant: SEIKO EPSON CORPORATION, Tokyo (JP)

(72) Inventors: Noriaki MURAYAMA, Azumino-Shi (JP); Takeshi HOSOKAWA, Shiojiri-Shi (JP); Masahiro OIDA, Matsumoto-Shi (JP); Yusuke HARIGAE, Azumino-Shi (JP)

(73) Assignee: SEIKO EPSON CORPORATION, Tokyo (JP)

(21) Appl. No.: 16/798,150

(22) Filed: Feb. 21, 2020

Related U.S. Application Data
(62) Division of application No. 15/534,997, filed on Jun. 9, 2017.

(30) Foreign Application Priority Data
Dec. 11, 2014 (JP) 2014-251245

(51) Int. Cl. B41J 3/407; B41J 11/00; B41J 5/30; B41J 21/00

(52) U.S. Cl. CPC B41J 3/4075; B41J 11/008; B41J 11/703; B41J 21/00; B41J 5/30

(57) ABSTRACT

A label creation apparatus that creates a punch block label, on which a number of a plurality of terminals on a punch block having the plurality of terminals grouped into two or more groups are printed, includes head number designation units that designates a head number of a numerical sequence for each group, and numerical sequence print units that assign the numerical sequence numbers continuously from the designated head number to each terminal and print the numerical sequence for each group.

### CROSS REFERENCE TO RELATED APPLICATIONS

This application is Divisional of U.S. application Ser. No. 15/534,997, which is the U.S. National Stage Application of PCT/JP2015/005738, filed on Nov. 17, 2015; which claims priority to Japanese Patent Application No. 2014-251245 filed on Dec. 11, 2014; the entire contents of both of which are incorporated by reference herein.

### TECHNICAL FIELD

The present invention relates to a label creation apparatus and a label creation system for creating a label on which numbers of a plurality of terminals on a terminal block are printed.

### BACKGROUND ART

In the related art, as a label creation apparatus of this type (terminal-board-symbol paper print-data creation apparatus), there is known a label creation apparatus including an input unit, a calculation unit that creates user terminal block symbol paper sheet data by using various data input from the input unit, and a print unit that prints the created user terminal block symbol paper sheet data on a sheet (see PTL 1). The apparatus creates a terminal block symbol paper corresponding to the label by printing the user terminal block symbol paper sheet data on the sheet.

In addition, the apparatus has a function of automatically assigning numbers to each terminal. In the automatic assignment function, when setting a radix, the head number, and an order of terminal numbering, a number (a so-called numerical sequence) of a continuous sequence starting with a head number set is automatically assigned to each terminal. Accordingly, it is possible to easily create the terminal block symbol paper to which a numerical sequence is added.

### CITATION LIST

### Patent Literature

PTL 1: Japanese Unexamined Patent Application Publication No. 2006-150739

### SUMMARY OF INVENTION

### Technical Problem

However, in the automatic assignment function of the apparatus, there is a problem that it is possible to add only one set (a series) of sequential numbers per terminal block symbol paper. For example, as shown in FIG. 2(a), in a case where a terminal block has upper and lower sets of terminal groups on upper and lower sides, different sequential numbers are requested to be added to each of the upper and lower sets. However, in the automatic assignment function, it is possible to add only a series of numerical sequence as shown in FIG. 2(b). Therefore, in a case where the different sequential numbers are added to each set, users have to manually input numbers one-by-one without using the automatic assignment function. As described above, usability is remarkably poor in the configuration of the related art.

The present invention provides a label creation apparatus and a label creation system capable of adding sequential numbers with a high degree of freedom when creating labels on which numbers of a plurality of terminals on a terminal block are printed.

### Solution to Problem

A label creation apparatus of the present invention that creates a label on which numbers of a plurality of terminals on a terminal block having the plurality of terminals grouped into two or more groups are printed, includes: a head number designation unit that designates a head number of a numerical sequence for each group; and a numerical sequence print unit that assigns numerical sequence numbers continuously from the designated head number to each terminal and prints the numerical sequence numbers for each group.

A label creation system of the present invention that creates a label on which numbers of a plurality of terminals on a terminal block having the plurality of terminals grouped into two or more groups are printed, includes: a head number designation unit that designates a head number of a numerical sequence for each group; and a numerical sequence print unit that assigns numerical sequence numbers continuously from the designated head number to each terminal and prints the numerical sequence numbers for each group.

According to the configuration, it is possible to designate the head number of the numerical sequence for each group, and it is possible to add (assign) different sequential numbers for each group to a single label. Therefore, it is possible to add sequential numbers with a high degree of freedom, and it is possible to easily create a label to which two or more sets of sequential numbers are added. Therefore, it is possible to improve usability.

In this case, it is preferable that an order be set for each group and that with the exception of the first group, the head number designation unit set a number following a tail number of the numerical sequence numbers in the previous group in the set order as an initial value at the time of designating the head number.

According to the configuration, since the number following the tail number of the numerical sequence in the previous group in the set order is set to the initial value at the time of designating the head number, if the initial value is designated as is, it is possible to add a series of numerical sequence across two groups. In this manner, it is also possible to easily add the series of numerical sequence between groups while maintaining the function of adding different sequential numbers for each group. Therefore, it is possible to further improve usability.

In addition, it is preferable that the label creation apparatus further include a group configuration designation unit that designates a group configuration, that the head number designation unit designate the head number of the numerical sequence numbers for each group based on the designated group configuration, and that the numerical sequence print unit assign the numerical sequence numbers to each terminal and prints the numerical sequence numbers for each group based on the designated group configuration.

According to the configuration, it is possible to add the sequential numbers with a higher degree of freedom.

In addition, it is preferable that the numerical sequence print unit assign the numerical sequence numbers to each block, which is a set of two or more terminals, instead of to each terminal and print the numerical sequence numbers.

In this case, it is preferable that the label creation apparatus further include: a block terminal number designation unit that designates the number of terminals per the block and that the numerical sequence print unit assign and print the numerical sequence numbers for each block based on the designated number of terminals.

According to the configuration, even when creating the label for printing the number in block units, it is possible to add the sequential numbers with a high degree of freedom.

### BRIEF DESCRIPTION OF DRAWINGS

FIG. 1 is a block diagram showing a configuration of a label creation apparatus according to an embodiment of the present invention.

FIG. 2 is a diagram showing an example of a created punch block label.

FIG. 3(a) is a diagram showing a block terminal number selection screen, FIG. 3(b) is a diagram showing a display number selection screen, FIG. 3(c) is a diagram showing a first head number input screen, FIG. 3(d) is a diagram showing a second head number input screen, and FIG. 3(e) is a diagram showing a frame length input screen.

FIG. 4 is a flowchart showing a label creation operation of the punch block label.

FIG. 5 is a screen transition diagram showing the label creation operation of the punch block label.

### DESCRIPTION OF EMBODIMENTS

Hereinafter, a label creation apparatus according to an embodiment of the present invention will be described with reference to the accompanying drawings. The label creation apparatus is a tape print apparatus which prints on an elongated print tape and creates a label (tape piece) by cutting a printed portion of the print tape. Particularly, the label creation apparatus has a function (hereinafter, referred to as punch block label creation function) of creating a punch block label to be affixed to a punch block (terminal block).

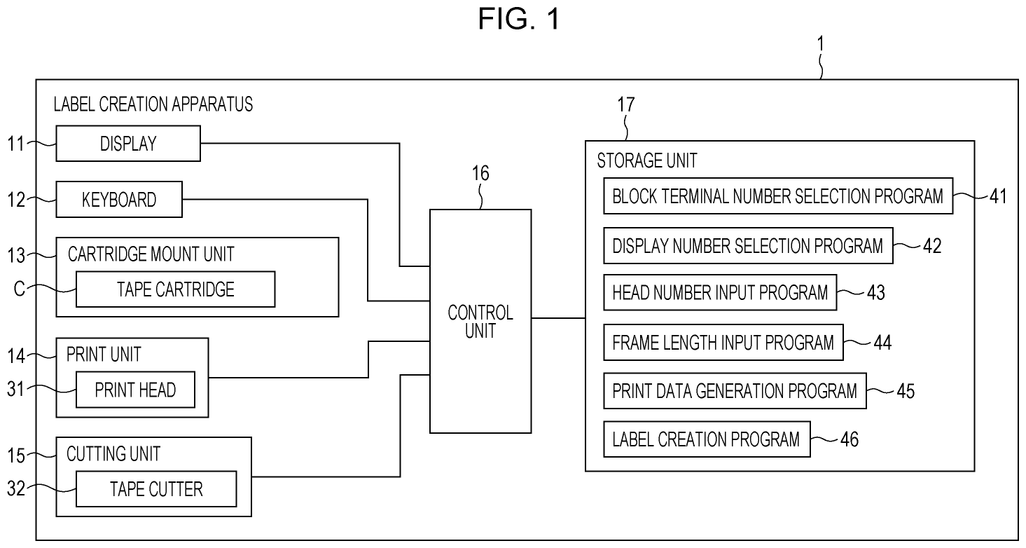

As shown in FIG. 1, a label creation apparatus 1 includes a display 11, a keyboard 12, a cartridge mount unit 13, a print unit 14, a cutting unit 15, a control unit 16, and a storage unit 17.

The display 11 displays various kinds of information during label creation, mainly various selection screens and various input screens.

The keyboard 12 is an operation unit to enable various operations to be performed, and the keyboard 12 functions as a selection unit for selecting various kinds of information and as an input unit for inputting various kinds of information.

The cartridge mount unit 13 enables a tape cartridge C in which the elongated print tape is accommodated to be detachably mounted thereon. The print tape accommodated in the tape cartridge C is formed by stacking a recording tape on which a printed image is formed on a surface thereof and a peeling tape affixed to the back side of the recording tape by a pressure-sensitive adhesive layer. The label created from the print tape is used by peeling a peeling tape portion from a recording tape portion and causing the recording tape portion to adhere to an object through use of the pressure-sensitive adhesive layer.

The print unit 14 includes a print head 31 and performs printing on the print tape fed out from the tape cartridge C. By this printing, a printed image is formed on a surface of the recording tape. On the other hand, the cutting unit 15 includes a tape cutter 32 and cuts the printed portion of the print tape. In the label creation apparatus 1, the label on which the printed image is formed on a surface thereof is created by printing on the print tape with the print unit 14 and cutting (separating) the printed portion with the cutting unit 15.

The control unit 16 is formed of a central processing unit (CPU), a read-only memory (ROM), a random access memory (RAM), and the like and controls the entire label creation apparatus 1. The control unit 16 controls each unit of the label creation apparatus 1 by executing each program stored in the storage unit 17.

The storage unit 17 is formed of a flash ROM or the like. Further, the storage unit 17 stores, as a program related to the punch block label creation function, a block terminal number selection program 41, a display number selection program 42, a head number input program 43, a frame length input program 44, a print data generation program 45, and a label creation program 46. In the present embodiment, by executing these programs in the control unit 16, the punch block label creation function is realized. Here, before explaining each program, a punch block label R created by the punch block label creation function will be described.

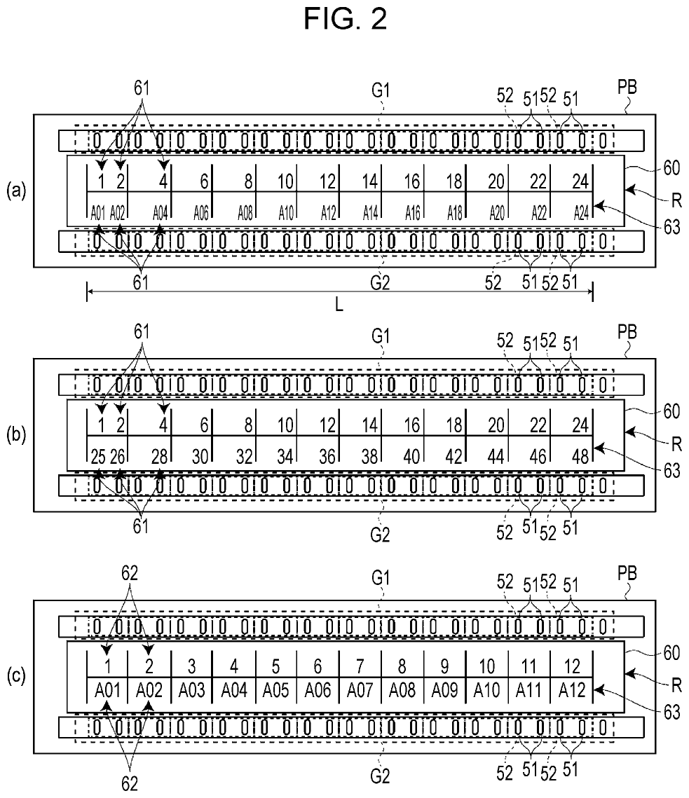

As shown in FIG. 2, the punch block label R is affixed to a punch block PB having a plurality of terminals (pins) 51. In the punch block PB, a plurality of terminals 51 are arranged as groups divided into a first group G1 of an upper row which is a first group and a second group G2 of a lower row which is a second group. On the other hand, the punch block label R is affixed between terminal groups of the groups G1 and G2. As shown in the same figure, the punch block label R shows mainly terminal numbers 61 of the plurality of terminals 51 and block numbers 62 of blocks 52, which are sets of two or more terminals 51 in the plurality of terminals 51. The blocks 52 correspond to a connector connected to the punch block PB, and the number of terminals per each block (hereinafter, referred to as the number of terminals per block) is determined according to the number of terminals of the connector. As will be described in detail below, the number of terminals per block is selected and set by users when creating the punch block label R.

FIGS. 2(a) and 2(b) are diagrams showing the punch block label R that shows the terminal numbers 61, and FIG. 2(c) is a diagram showing the punch block label R that shows the block numbers 62. As shown in FIG. 2, the punch block label R is formed by printing the terminal numbers 61 of a plurality of terminals 51 or the block numbers 62 of a plurality of blocks 52 and a partition frame 63 corresponding to each block 52, on a tape piece 60 formed by cutting a print tape. Each terminal number 61 and each block numbers 62 are arranged at positions corresponding to each terminal 51 or each block 52 at the upper or lower portion of the tape piece 60. The plurality of terminal numbers 61 and the plurality of block numbers 62 are numerical sequence numbers for each series or each group. As shown in FIGS. 2(a) and 2(b), in the punch block label R showing the terminal numbers 61, only the tail number of the terminal numbers 61 is printed, and printing of a subsequent number of the terminal numbers 61 is omitted in each block 52 excluding the block 52 of the left end.

Returning to FIG. 1, the block terminal number selection program 41, the display number selection program 42, the head number input program 43, the frame length input program 44, the print data generation program 45, and the label creation program 46 will be described.

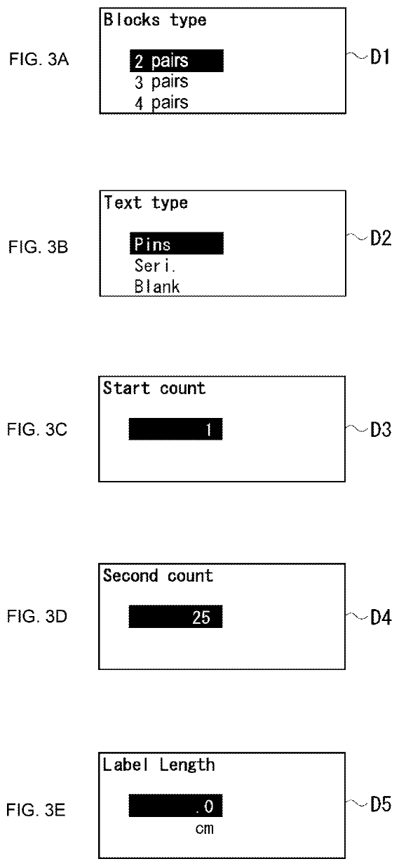

The block terminal number selection program 41 is a program for receiving selection (designation) of the number of terminals per block from the keyboard 12 by displaying a block terminal number selection screen D1 (see FIG. 3(a)). That is, the control unit 16 displays the block terminal number selection screen D1 and receives the selection of the block terminal number from the keyboard 12 in accordance with the block terminal number selection program 41. In this manner, a “block terminal number designation unit” is formed of the keyboard 12, the control unit 16, and the block terminal number selection program 41. In the selection of the number of terminals per block, two (“2 pairs”), three (“3 pairs”), four (“4 pairs”), five (“5 pairs”), and an unspecified (“Blank”) option can be selected as the number of terminals per block.

The display number selection program 42 is a program for receiving selection (designation) of a display number from the keyboard 12 by displaying a display number selection screen D2 (see FIG. 3(b)). That is, the control unit 16 displays the display number selection screen D2 and receives the selection of the display number from the keyboard 12, in accordance with the display number selection program 42. In the selection of the display number, it is possible to select whether the number represented on the punch block label R is the terminal numbers 61 or the block numbers 62. More specifically, as the display number, the terminal numbers 61 (“Pins”), the block numbers 62 (“Seri.”), and the unspecified (“Blank”) option can be selected.

The head number input program 43 is a program for receiving input of the head number of the numerical sequence from the keyboard 12 by displaying the head number input screens D3 and D4. That is, in accordance with the head number input program 43, the control unit 16 displays the head number input screens D3 and D4 and receives the input of the head number from the keyboard 12. In this manner, the “head number designation unit” is formed of the keyboard 12, the control unit 16, and the head number input program 43. In the input of the head number, the head number can be input (designated) for each of the above-described groups. That is, in accordance with the head number input program 43, the control unit 16 receives the input of the head number of the numerical sequence of the first group G1 by displaying a first head number input screen D3 (see FIG. 3(c)) for inputting the head number of the numerical sequence of a first group G1. In addition, the control unit 16 receives the input of the head number of the numerical sequence of the second group G2 by displaying a second head number input screen D4 (see FIG. 3(d)) for inputting the head number of the numerical sequence of the second group G2 in accordance with the head number input program 43. As will be described below in detail, in the input of the head number of the second group G2, a number following the tail number of the numerical sequence of the first group G1 is set as an initial value at the time of inputting.

The frame length input program 44 is a program for receiving input of a frame length L (see FIG. 2 (a)) of the partition frame 63 from the keyboard 12 by displaying a frame length input screen D5 (see FIG. 3(e)). That is, the control unit 16 receives the input of the frame length L of the partition frame 63 from the keyboard 12 by displaying the frame length input screen D5 in accordance with the frame length input program 44.

The print data generation program 45 is a program for generating print data for creating the punch block label R based on each selection result of each selection and input results of each input operation described above. That is, in accordance with the print data generation program 45, the control unit 16 generates the print data based on each selection result of each selection and input results of each input operation described above. Specifically, based on the number of terminals per block and the frame length L, the partition frame 63 is generated, and a numerical sequence continuous from the head number is generated for each group, based on the number of terminals per block, the display number, and the head number according to the number of the terminals 51 and the blocks 52 to be an assignment target. Accordingly, the generated partition frame 63 is disposed at a predetermined location, and the generated numerical sequence for each group is assigned to and disposed on each terminal 51 or each block 52. That is, generated sequential numbers for each group are assigned to each terminal 51 or each block 52 within each group and are disposed at a location corresponding to each terminal 51 or each block 52 as individual numbers of the terminal numbers 61 or the block numbers 62 in a numerical order from the left. Thus, print data is generated.

As described above, in a case where the terminal numbers 61 are selected as the display number, a part of the terminal numbers 61 are omitted. That is, in each block 52 excluding the block 52 of the left end, only the terminal numbers 61 of the tail are disposed, and the disposition of other terminal numbers 61 is omitted.

The label creation program 46 is a program for performing a printing process and a cutting process (label creation process) based on the print data generated by the print data generation program 45 by controlling the print unit 14 and the cutting unit 15. That is, in accordance with the label creation program 46, the control unit 16 performs the printing process and the cutting process based on the print data. Specifically, the print unit 14 prints the print data on the print tape, and the cutting unit 15 cuts the print tape to a tape length based on the print data. Thus, the punch block label R is created. The “numerical sequence print unit” is formed of the control unit 16, the print data generation program 45, and the label creation program 46.

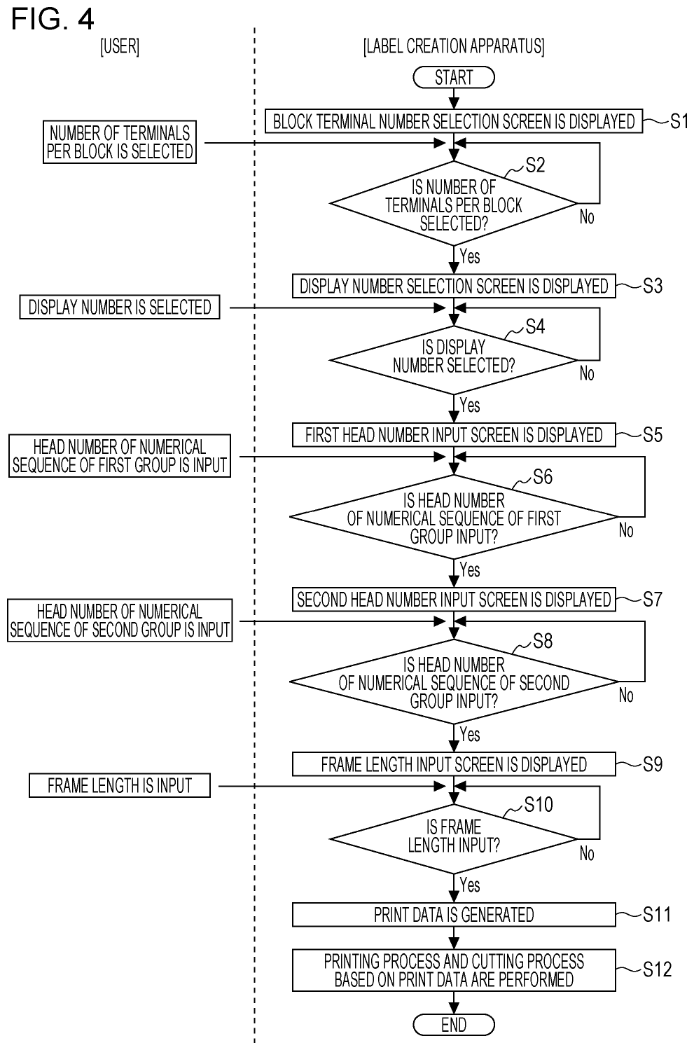

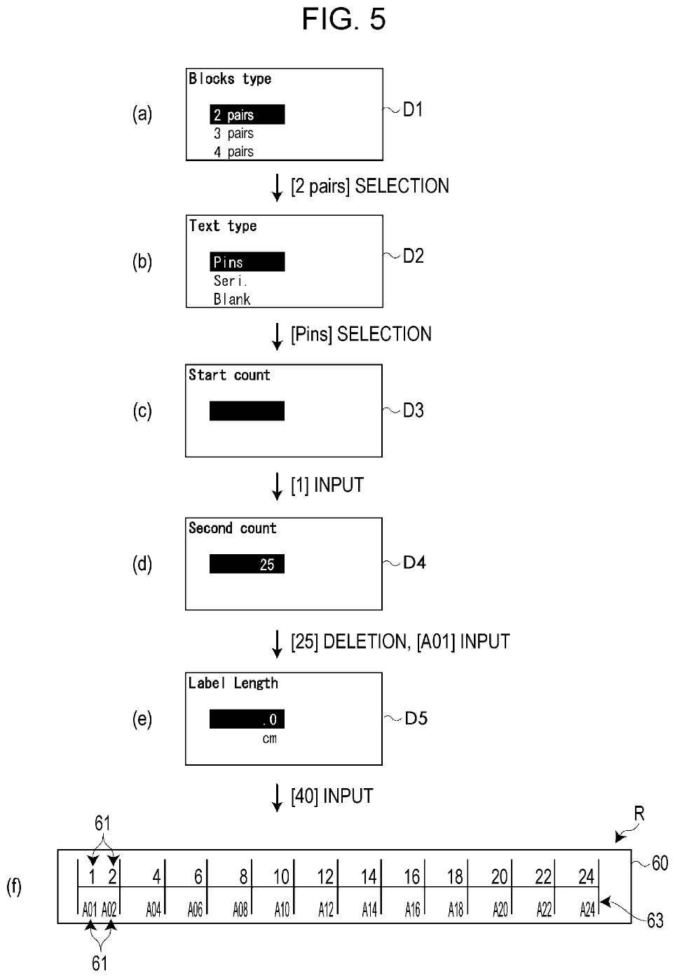

Next, with reference to FIG. 4 and FIG. 5, a label creation operation for creating the punch block label will be described. It is assumed that the label creation operation is performed in a state where a punch block label creation mode, as a print mode, using a punch block label creation function is selected and the print mode is shifted to the punch block label creation mode by using the keyboard 12.

As shown in FIG. 4, when shifting to the punch block label creation mode, the control unit 16 displays the block terminal number selection screen D1 in accordance with the block terminal number selection program 41 (S1) and receives the selection of the number of terminals per block (S2) (see FIG. 5(a)). On the other hand, a user selects the number of terminals per block by using the keyboard 12. Although not shown, in a case where the unspecified (“Blank”) option is selected in the selection, selection of the display number (S3 and S4) and selection of respective head numbers (S5 to S8) are skipped, and the process transitions to the inputting of the frame length L (S9 and S10).

If the number of terminals per block is selected (S2: Yes), the control unit 16 displays the display number selection screen D2 (S3) in accordance with the display number selection program 42 and receives the selection of the display number (S4) (see FIG. 5(b)). On the other hand, a user selects the display number by using the keyboard 12. Although not shown, in a case where the unspecified (“Blank”) option is selected in the selection, selection of each head number (S5 to S8) is skipped, and the process transitions to the inputting of the frame length L (S9 and S10).

If the presentation number is selected (S4: Yes), the control unit 16 displays the first head number input screen D3 in accordance with the head number input program 43 (S5) and receives input of the head number of the numerical sequence of the first group G1 (S6) (see FIG. 5(c)). On the other hand, a user inputs the head number of the numerical sequence of the first group G1 by using the keyboard 12.

If the head number of the numerical sequence of the first group G1 is input (S6: Yes), the control unit 16 displays the second head number input screen D4 in accordance with the head number input program 43 (S7) and receives input of the head number of the numerical sequence of the second group G2 (S8) (see FIG. 5(d)). At this time, the tail number of the numerical sequence of the first group G1 is calculated based on the number of terminals and the display number of the selected block and the head number of the numerical sequence of the first group G1 that is input, and the number following the tail number is set as an initial value for the input of the second head number. That is, the number following the tail number is displayed in an editable manner on the second head number input screen D4 as the initial value. For example, in a case where the number of terminals per block is two and the display numbers of the terminal numbers 61 are displayed, the number of numbers assigned in the first group G1 is 24. In this case, when the head number of the numerical sequence is “1”, the tail number of the numerical sequence is “24”. Therefore, “25”, following “24”, is set as an initial value of an input of the second head number. On the other hand, a user inputs (designates) the head number of the numerical sequence of the second group G2 by the keyboard 12. In a case where the initial value is set as is as the head number of the numerical sequence of the second group G2, the initial value is designated as is as the head number without needing to be input.

If the head number of the numerical sequence of the second group G2 is input (designated) (S8: Yes), the control unit 16 displays the frame length input screen D5 (S9) and receives input of the frame length L (S10) (see FIG. 5(e)), in accordance with the frame length input program 44. On the other hand, a user inputs the frame length L by the keyboard 12.

If the frame length L is input (S10: Yes), the control unit 16 generates print data based on the selection result and the input result of each process in accordance with the print data generation program 45 (S11). That is, based on the number of terminals per block and the frame length L, the partition frame 63 is generated, and the numerical sequence, which is continuous from the head number, and based on the number of the terminals 51 and the blocks 52 to be an assignment target is generated based on the number of terminals per block, the display number, and the head number, for each group. Thus, the generated partition frame 63 is disposed at a predetermined location, and generated sequential numbers are assigned to and disposed on each terminal 51 or each block 52 within each group, and thereby the print data is generated, for each group. As a result, the print data to which the sequential numbers for each group are added is generated. In a case where the unspecified (“Blank”) option is selected in the selection of the number of terminals per block (S2) or selection of the display number (S4), the print data of only the partition frame 63 is generated without generation and disposition of the sequential numbers.

After generating the print data, the control unit 16 controls the print unit 14 and the cutting unit 15 in accordance with the label creation program 46, and performs the printing process and the cutting process based on the print data (S12). In the print data, the numerical sequence numbers for each group are assigned to and disposed on each terminal 51 or each block 52 within each group, as the terminal numbers 61 or the block numbers 62. Therefore, by the printing process, the numerical sequence numbers of each group are assigned to each terminal or each block within each group and printed. As a result, the punch block label R to which the sequential numbers for each group are added is created. Thus, the label creation operation is ended.

According to the configuration, since a configuration in which the head number of the numerical sequence can be designated for each group, and the numerical sequence continuous from the designated head number is assigned to each terminal 51 or each block 52 for each group, as the terminal numbers 61 or the block numbers 62 and printed, is implemented, it is possible to add (assign) different sequential numbers for each group to a single punch block label R. Therefore, it is possible to add the sequential numbers with the high degree of freedom, and it is possible to easily create the punch block label R to which two or more sets of sequential numbers are added. Thus, it is possible to improve the usability.

In addition, for each group excluding the first group in the order, by setting the number following the tail number of the numerical sequence in the previous group in the order as an initial value at the time of designating the head number, if the initial value is designated as is, it is possible to add a series of numerical sequence across two groups. Therefore, it is also possible to easily add the series of numerical sequence between groups while maintaining the function of adding the different sequential numbers for each group. Thus, it is possible to further improve the usability.

In the embodiment, the block 52 corresponds to a connector. However, since it is conceivable to connect a connector unit in which a plurality of connectors are grouped together to the punch block PB, the block 52 may correspond to the connector unit.

In addition, the embodiment is configured to create the punch block label R that represents the terminal numbers 61 and the block numbers 62. However, in addition to the terminal numbers 61 and the block numbers 62, the embodiment may be configured to create the punch block label R that represents a connection destination name of the terminal 51 and the block 52. In addition, in such a case, it is preferable to use a numerical sequence for each group also with respect to the connection destination name. That is, with respect to the connection destination name, the head number of the numerical sequence for each group is input (designated) and the numerical sequence for each group is generated, and thereby generated sequential numbers are assigned to each terminal 51 and each block 52 and printed. For example, a “conference room 1” is input as the head number of the first group G1, a numerical sequence (conference room 1, conference room 2, conference room 3, . . . ) continuous from the “conference room 1” is generated, a “reception room 1” is input as the head number of the second group G2, and a numerical sequence (reception room 1, reception room 2, reception room 3, . . . ) continuous from the “reception room 1” is generated. Thus, these are assigned to each terminal 51 and each block 52 as the connection destination name and printed.

Furthermore, the embodiment is implemented as a configuration in which the terminal group in the upper row is set as the first group G1, the terminal group in the lower row is set as the second group G2, and the sequential numbers are added for each group. However, the configuration of the group is not limited thereto. For example, a configuration in which the terminal group of the upper row and the terminal group of the lower row are respectively divided into two or four in right and left, that is, grouped into four groups or eight groups, and sequential numbers of four sets or eight sets are added, may be implemented. In addition, the group configuration may be arbitrarily set by users. That is, the label creation apparatus 1 further includes the group configuration designation unit (control unit 16 and group configuration selection program) for selecting (designating) the group configuration by users. Accordingly, the head number designation unit (keyboard 12, control unit 16, and head number input program 43) designates the head number of the numerical sequence for each group based on the group configuration designated by the group configuration designation unit. In addition, the numerical sequence print unit (control unit 16, print data generation program 45, and label creation program 46) assigns the numerical sequence numbers continuously from the head number for each group based on the group configuration designated by the group configuration designation unit, to each terminal 51 or each block 52 and prints the numerical sequence. According to such a configuration, it is possible to add the sequential numbers with a higher degree of freedom.

In the embodiment, the punch block label R to be affixed to the punch block PB installed in a sideways posture is created. However, a configuration in which the punch block label R to be affixed to the punch block PB installed in an upright position is created, may be implemented. In turn, a configuration in which this can be selected by users, may be implemented. In a case where the punch block label R to be affixed to the punch block PB installed in the upright posture is created, each terminal numbers 61 and block numbers 62 of the punch block label R shown in FIG. 2 are printed sideways.

In addition, in the embodiment, the present invention is applied to the label creation apparatus 1. However, the present invention may be applied to a label creation system SY formed by connecting a host computer 101 and the label creation apparatus 1. In such a case, a storage unit of the host computer stores the block terminal number selection program 41, the display number selection program 42, the head number input program 43, the frame length input program 44, and the print data generation program 45. In a host computer side, above-described each selection and each input are received, and the print data is generated based on the reception. On the other hand, the storage unit 17 of the label creation apparatus 1 stores the label creation program 46, and the printing process and the cutting process are performed based on the print data generated by the host computer in a label creation apparatus 1 side.

### REFERENCE SIGNS LIST

1 LABEL CREATION APPARATUS
12 KEYBOARD
16 CONTROL UNIT
51 TERMINAL
52 BLOCK
43 HEAD NUMBER INPUT PROGRAM
45 PRINT DATA GENERATION PROGRAM
46 LABEL CREATION PROGRAM
PB PUNCH BLOCK
R PUNCH BLOCK LABEL

1.-6. (canceled)

7. A label creation apparatus that creates a label on which numbers of a plurality of terminal blocks each comprising two or more terminals are printed, wherein the plurality of terminal blocks are grouped into at least a first group and a second group, the apparatus comprising:
a head number designation unit configured to designate a group head number of a numerical sequence for each of the first group and the second group; and
a control unit configured to assign numerical sequence numbers continuously from the designated group head number to each of the plurality of terminal blocks and cause a print unit to print the numerical sequence numbers for each of the first group and the second group.

8. The label creation apparatus according to claim 7, further comprising:
a group configuration designation unit that designates a group configuration,
wherein the head number designation unit designates the group head number of the numerical sequence numbers for each of the first group and the second group based on the designated group configuration, and
the control unit is configured to assign the numerical sequence numbers to each of the plurality of terminal blocks and cause the print unit to print the numerical sequence numbers for each of the first group and the second group based on the designated group configuration.

9. The label creation apparatus according to claim 7, further comprising:
a block terminal number designation unit that designates the number of terminals per the block,
wherein the control unit is configured to assign the numerical sequence numbers to each of the plurality of terminal blocks based on the designated number of terminals and cause the print unit to print the numerical sequence numbers for each of the plurality of terminal blocks based on the designated number of terminals.

10. A label creation system that creates a label on which numbers of a plurality of terminal blocks each comprising two or more terminals are printed, wherein the plurality of terminal blocks are grouped into at least a first group and a second group, the system comprising:
a head number designation unit configured to designate a group head number of a numerical sequence for each of the first group and the second group; and
a control unit configured to assign numerical sequence numbers continuously from the designated group head number to each of the plurality of terminal blocks and cause a print unit to print the numerical sequence numbers for each of the first group and the second group.
